(19) United States
(12) Patent Application Publication
(10) Pub. No.: US 2016/0224950 A1
(43) Pub. Date: Aug. 4, 2016

(54) Method for Consolidating Multiple Merchants Under a Common Merchant Payment System

(71) Applicant: Michael J. Attar, Westhampton, NY (US)

(72) Inventor: Michael J. Attar, Westhampton, NY (US)

(21) Appl. No.: 15/013,910

(22) Filed: Feb. 2, 2016

Related U.S. Application Data
(60) Provisional application No. 62/110,987, filed on Feb. 2, 2015.

(51) Int. Cl. G06Q 20/02; G06Q 20/40; G06Q 20/20; G06Q 20/38

(52) U.S. Cl. CPC G06Q 20/027; G06Q 20/382; G06Q 20/401; G06Q 20/20

(57) ABSTRACT

A method for an alternative merchant payment system for a plurality of merchant accounts that allows each merchant accounts to utilize their own hardware and software. The overall process begins with sending payment request information from a corresponding point of sale (POS) terminal to a secure reading and exchange of data (SRED) reader of an arbitrary account. The SRED reader then sends the payment request information and payment instructions to a secure server through a symmetric or asymmetric encryption. The secure server receives and re-encrypts the payment request information and the payment instructions with a merchant public key associated with the arbitrary account. The re-encrypted payment request information and the payment instructions are then sent to the corresponding POS terminal in order to be used as input to complete a payment transaction.

The current application claims a priority to the U.S. Provisional Patent application Ser. No. 62/110,987 filed on Feb. 2, 2015.

### FIELD OF THE INVENTION

The present invention relates generally to a method for receiving and processing transactions through a point of sale terminal, also known as a merchant payment system. More specifically, the present invention consolidates multiple merchants through a common merchant payment system in order to allow each merchant to utilize their own point of sale application, point of sale hardware, and payment service processor.

### BACKGROUND OF THE INVENTION

Currently, merchants such as restaurants and other similar establishments utilize a point of sale (POS) terminal in conjunction with a secure payment receiving device to process their day to day customer transactions. The POS terminal is a computing device that is physically located at the establishment and runs a POS software application; the POS terminal is connected to the Internet and the payment receiving device. Through the aforementioned components, a server/cashier can take an order, request payment information, receive payment information, credit card processing, and provide a receipt to the customer to name a few of the functions; modern POS system also keep track of inventory, employee working hours/schedules, profits, and other similar statistics. It is important to note the steps taken for credit card processing as the present invention affects this process directly. In order for the establishment to be able to receive credits cards as form of payments, the hardware and software being used must meet the payment card industry data security standards (PCI DSS). According to the PCI DSS, cardholder data is to be encrypted when being transmitted through public networks; access to said data should be restricted to need-to-know personnel; and, the flow of said data is to be tracked and monitored at all times. Merchants/establishments comply with these rules through the use of secure networks and secure payment receiving devices. A secure payment-receiving device is a device which reads payment information from a credit card and immediately encrypts said information. The majority of secure payment receiving devices are stand-alone devices which read the magnetic band on a credit card in order to obtain payment information. Because the secure payment receiving device encrypts the payment information before sending it to the POS terminal, there is little chance that the cardholder data can be copied.

The payment receiving device encrypts payment information such that only an approved financial entity, the bank of the establishment, is able to decrypt and view it. More specifically, the payment receiving device encrypts the payment information using a public-private key algorithm, wherein the establishment is provided with the public key and the financial entity is provided with the private key; this creates a secure line of communication between the two parties. In order to comply with the PCI DSS rules, each of the payment receiving devices is only allowed to encrypt received data with a single public key, thus increasing the security level of the cardholder data significantly. This forces each establishment to purchase or rent their own set of payment receiving devices and subscribe to the associated payment receiving services, each utilizing different software and requiring maintenance; the overall payment system is also known as a merchant payment system. A merchant payment system includes the hardware, software, and services required to securely receive, send, and process customer financial information, i.e. cardholder data. Even if the establishments are located in the same location, each establishment is required to purchase or subscribe to their merchant payment system. This is financially inefficient since most merchant payment systems perform similar tasks with only minor variations in methodology and security. It is therefore an objective of the present invention to introduce a system which acts as an intermediary between disparate POS terminals of different establishments, thus allowing multiple merchants to use a common merchant payment system while simultaneously using their own POS terminals, POS software/applications, and payment receiving devices.

### BRIEF DESCRIPTION OF THE DRAWINGS

FIG. 1 is a flowchart illustrating the overall process of the present invention.

FIG. 2 is a flowchart illustrating the sub-steps necessary for generating payment request by information with a point of sale (POS) terminal and receiving payment instructions by a secure reading and exchange of data (SRED) reader.

FIG. 3 is a flowchart illustrating the sub-steps necessary for identifying a desired public key with the use of a merchant identification (ID).

FIG. 4 is a flowchart illustrating the sub-steps necessary for transmitting data from the SRED reader to a secure server through an asymmetric encryption.

FIG. 5 is a flowchart illustrating the sub-steps necessary for transmitting data from the SRED reader to a secure server through a symmetric encryption.

FIG. 6 is a flowchart illustrating the sub-steps necessary for executing a payment transaction with the payment request information and the payment instructions as inputs.

FIG. 7 is a flowchart illustrating the logging and tracking feature of the present invention.

FIG. 8 is a system diagram of the present invention.

### DETAIL DESCRIPTIONS OF THE INVENTION

All illustrations of the drawings are for the purpose of describing selected versions of the present invention and are not intended to limit the scope of the present invention.

The present invention is a method for an alternative merchant payment system. More specifically, the present invention is a merchant payment system for a multitude of merchants that allows each merchant to utilize his or her own point of sale application, point of sale terminal, and payment service processor. Contrary to traditional payment systems, the present invention does not require each of the merchants to rent or buy customized hardware or software. The reason that traditional payment systems require individually customized hardware, card readers for example, is to ensure that the transactions and communications executed by and with the merchant are encrypted and secure to a specific degree; more specifically, up to the standards set by the payment card industry data security standards (PCI DSS). The present invention utilizes an intermediate entity to encrypt and redirect transaction information for each of a multitude of merchants simultaneously, tasks that are traditionally executed by the payment receiving device. The present invention utilizes encrypted connections and payment card industry (PCI) certified hardware in order to meet PCI DSS.

The present invention provides a means for securely transmitting and executing monetary transactions for a plurality of merchant accounts through a common merchant payment system, wherein each of the merchant accounts corresponds to a specific establishment like a McDonalds or a Burger King. A merchant account allows a user to access the present invention and allows the present invention to distinguishing between each user. Each merchant account is further associated with a merchant public key, an at least one secure reading and exchange of data (SRED) reader, and an at least one corresponding point of sale (POS) terminal. The merchant public key is part of a public-private key encryption that is used to securely transmit data in between a merchant account and a banking entity. Complimentary to the merchant public key, the banking entity contains a merchant private key that is necessary to decrypt the transmitted data. This is an existing line of communication between each merchant account and their respective banking entities. The present invention does not affect or interfere with this connection, thus creating a solution that is compatible with existing hardware and software.

The POS terminal is a computing device that is physically located at the establishment of each merchant account and provides a means for processing a transaction between the merchant account and a customer(s). A transaction includes, but is not limited to, receiving product information, producing an invoice, requesting payment information, receiving payment information, and sending the payment information to the proper financial institute, the banking entity for example. This is achieved through the use of an at least one user interface of the POS terminal. The SRED reader is a physical device which receives financial information from a customer and subsequently encrypts said information before transmitting it to the POS terminal or any other entity. This ensures that the financial information of the customer cannot be viewed or copied while it is transmitted through the POS terminal and any other intermediate entity in between the merchant account and the banking entity of said merchant account; this is one of the requirements set forth by the PCI DSS. An example of a SRED reader is a magnetic stripe reader; the SRED reader may also be equipped the components and software necessary to support any type of current payment media including, but not limited to, chip and pin ecommerce, checks, and other similar payment instruments. The secure server stores the merchant public key for each merchant account and is in charge of receiving transaction information from the SRED reader/POS terminal and encrypting said information with the appropriate merchant public key.

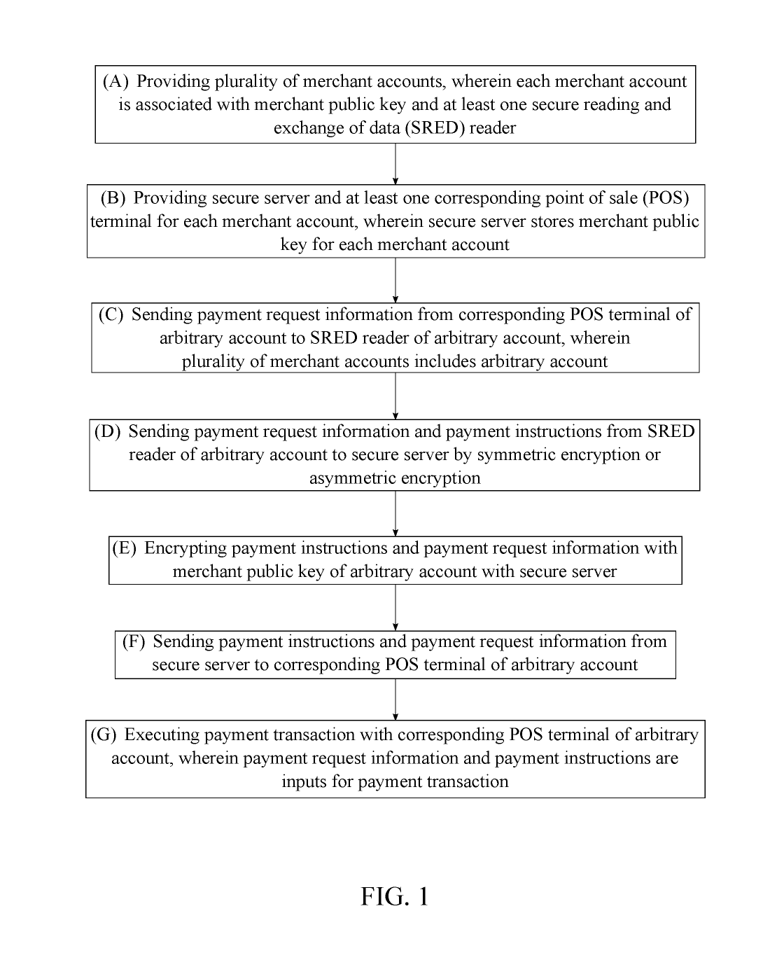

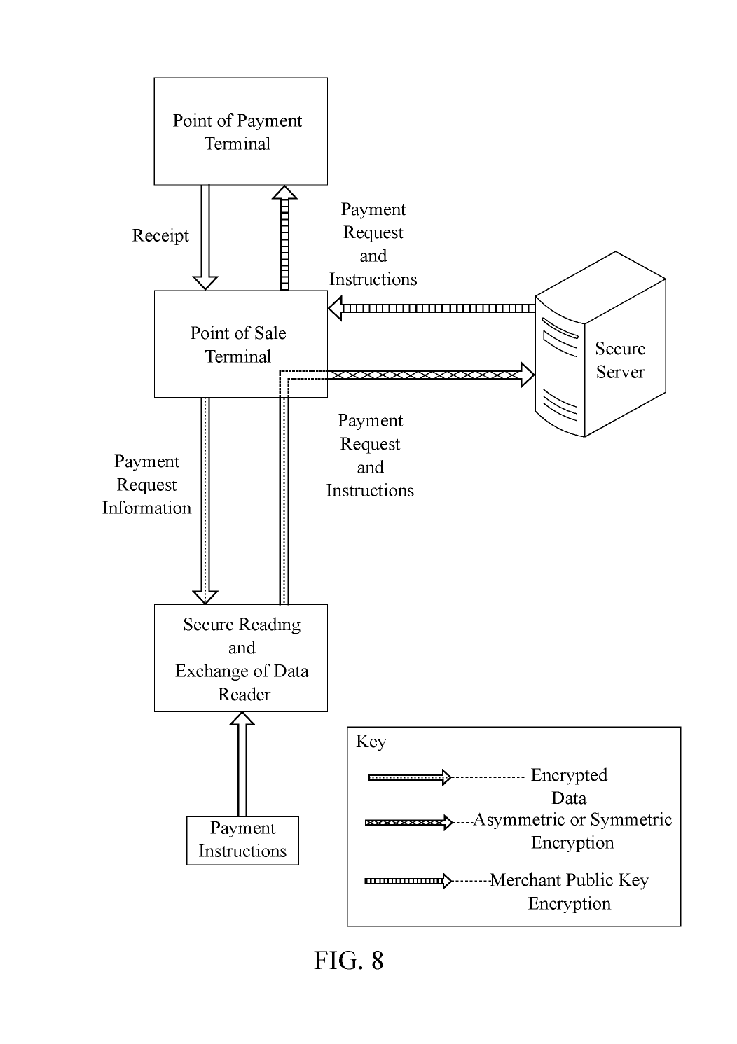

As can be seen in FIG. 1, the method of the present invention follows a primary process in order to securely transmit transaction data from the plurality of merchant accounts to their respective banking entities, wherein the transaction data is encrypted with the merchant public key associated with the merchant account which sent the transaction data. The overall process is disclosed in relation an arbitrary account, the arbitrary account represents any one of the merchant accounts. Furthermore, the components and their relative communication lines are depicted in the schematic diagram of the present invention seen in FIG. 8. The primary process begins when payment request information is sent from the corresponding POS terminal of an arbitrary account to an SRED reader of the arbitrary account, wherein the plurality of merchant accounts includes the arbitrary account (Step C). The payment request information includes, but is not limited to, a list of products, individual product price, total price, POS terminal identification (ID), time stamp, transaction number, and other pertinent information. The SRED reader of the arbitrary account then prompts a customer to provide payment instructions; the payment instructions are the customer's personal financial information. Payment instructions may be entered through a variety of mediums as described above and may include, but is not limited to, bank name, banking number, cardholder name, expiration date, and a card security code. The payment instructions and the payment request information are then sent from the SRED reader of the arbitrary account to the secure server by a symmetric encryption or an asymmetric encryption (Step D), described in further detail below.

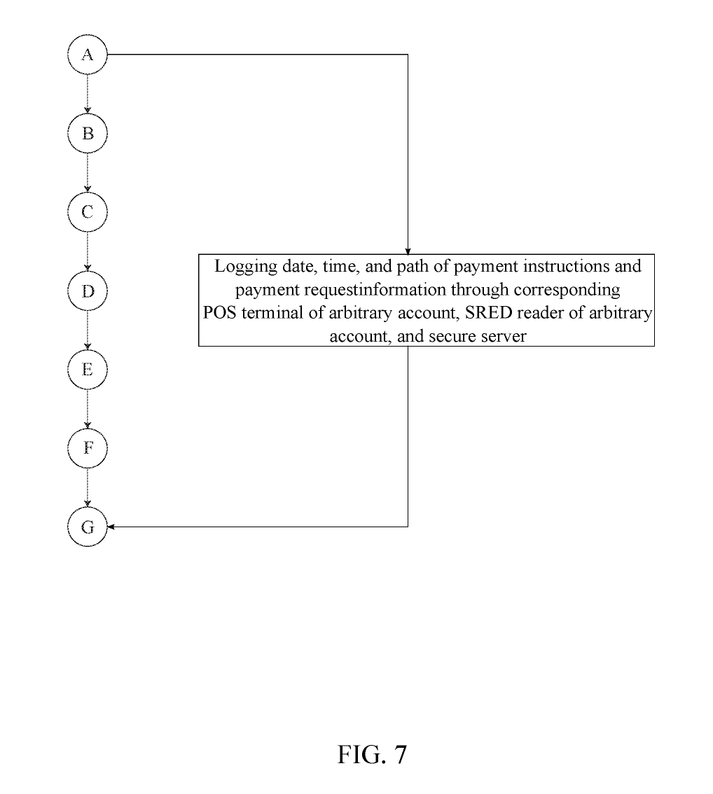

Once received, the secure server decrypts the payment request information and the payment instructions in order identify the merchant public key of the arbitrary account. The merchant public key of the arbitrary account is then used to encrypt the payment instructions and the payment request information (Step E). Traditionally, the payment instructions are encrypted with the merchant public key by the SRED reader. Through the aforementioned steps, the present invention securely transitions this step/process to the secure server instead, this resultantly allows the associated establishments to utilize a variety of different hardware and software while still abiding by the security protocols set forth by the PCI DSS. The next step in the overall process is sending the payment instructions and the payment request information from the secure server to the corresponding POS terminal of the arbitrary account (Step F). This allows the corresponding POS terminal of the arbitrary account to execute a payment transaction with an external financial entity, wherein the payment instructions and the payment request information are inputs for the payment transaction (Step G). Throughout the process, the present invention logs the date, time, and path of the payment instructions and the payment request information through the corresponding POS terminal of the arbitrary account, the SRED reader of the arbitrary account, and the secure server as illustrated in FIG. 7.

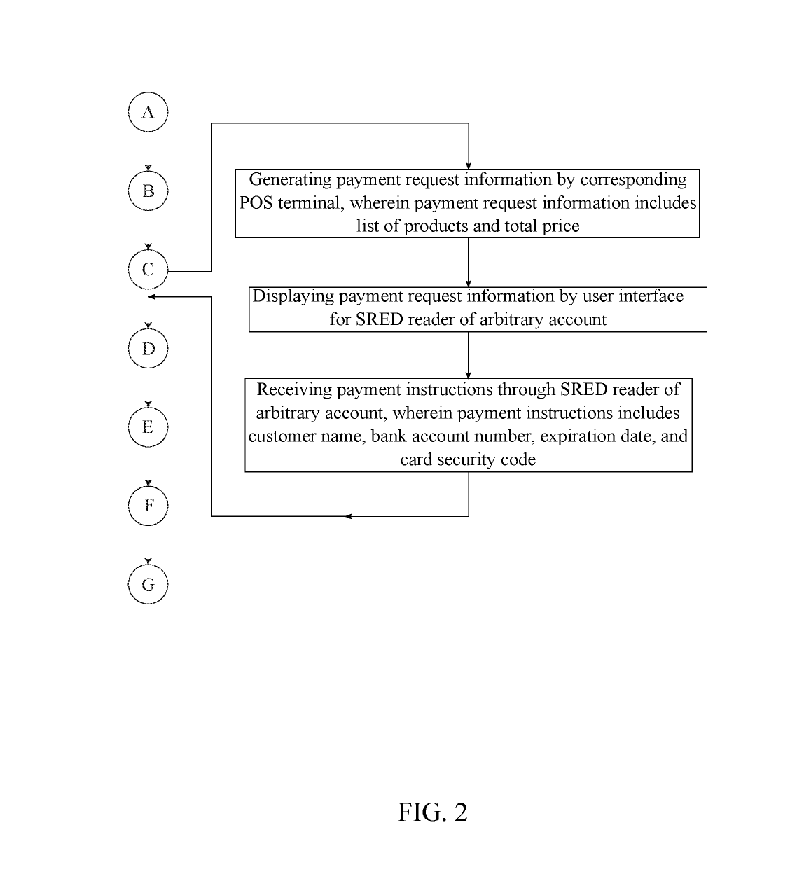

Referring to FIG. 2, another secondary process implemented by the present invention is receiving payment request information and payment instructions. In relation to the overall process, obtaining this information is executed prior to Step C. First, the payment request information is received by the corresponding POS terminal through the user interface of the POS terminal. More specifically, a cashier enters the product identification, product price, shipping request, number of products, and/or other similar information into the corresponding POS terminal through the user interface. The corresponding POS terminal uses this information to generate the payment request, wherein the payment request information includes at least a list of products, total price, and POS terminal identification. Alternative information may be used for the payment request information in order to meet the needs of the establishment, the merchant account. The payment request information is then displayed by a user interface of the SRED reader or the arbitrary account and/or by the user interface of the corresponding POS terminal, thus prompting the customer to enter payment information through the SRED reader of the arbitrary account. Once the SRED reader receives the payment information, the SRED reader converts the payment information into a standard that is accepted by the banking entity, named payment instructions for the present invention. The payment instructions include, but are not limited to, customer name, a banking account number, an expiration date, and a card security code.

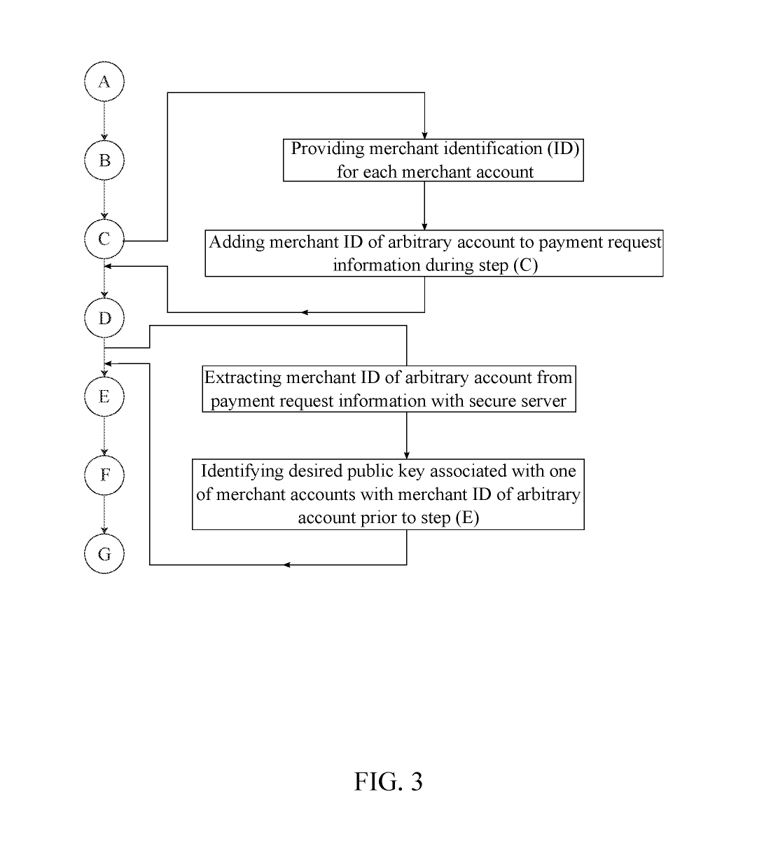

Referring to FIG. 3, another secondary process implemented by the present invention is identifying the proper merchant public key to use during Step E. This is achieved by assigning a merchant identification (ID) to each of the plurality of merchant accounts. The merchant ID may be the name of the establishment, a number, a sequence of numbers and letters, or any other means of unique identifiers. The merchant ID for each merchant account is stored on the secure server with each merchant ID being associated with a corresponding merchant public key. In relation to the overall process for the present invention, during Step C, the merchant ID of the arbitrary account is added to the payment request information. Prior to Step E, the merchant ID of the arbitrary account is extracted from the payment request information with the secure server. The merchant ID of the arbitrary account is then used to identify a desired public key associated with one of the merchant accounts.

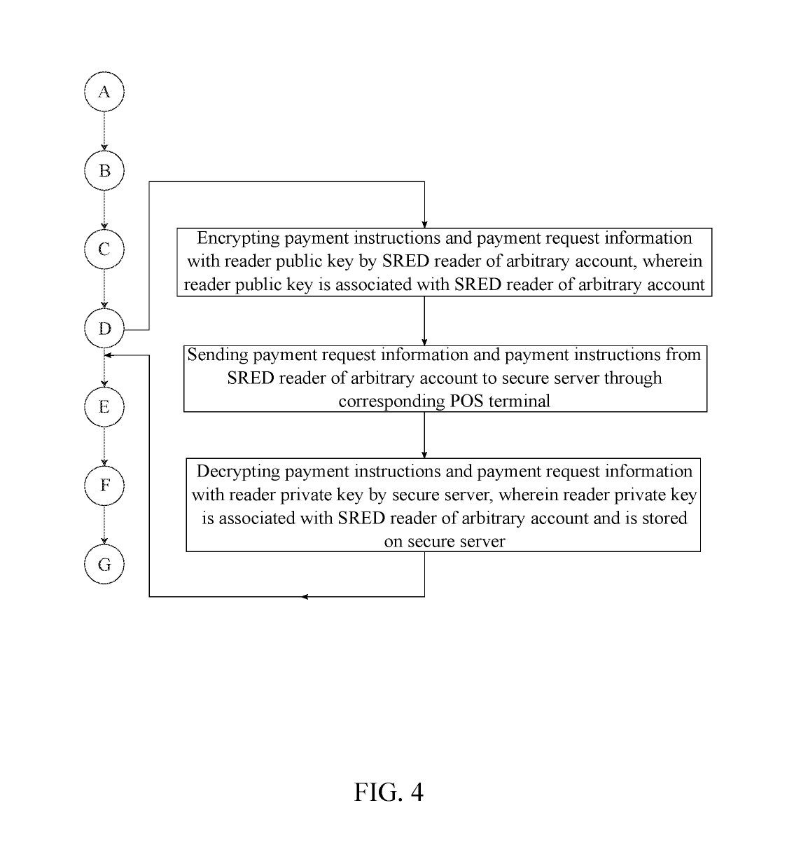

Referring to FIG. 4, in one embodiment of the present invention, data transmitted in between the SRED reader and the secure server is protected through an asymmetric encryption. The asymmetric encryption allows for the encrypted information to be sent to various entities which do not or may not hold the private key, ideal for situations where data needs to be processed, tracked, and modified through a third party; the disadvantage of using asymmetric encryption is that more time is required to encrypt the message when compared to alternative means. This embodiment is ideal for establishments that process large transactions and value security. For example, private doctor offices and legal firms would prefer this type of encryption.

In this embodiment, the SRED reader of each merchant account is pre-programmed with a public key while a complimentary private key for the SRED reader of each merchant account is stored on the secure server. In relation to the overall process of the present invention, the following steps are executed during Step D. For sending data from the SRED reader of the arbitrary account to the secure server by an asymmetric encryption, first, the SRED reader of the arbitrary account encrypts the payment instructions and the payment request information into encrypted data with a reader public key, wherein the reader public key is associated with the SRED reader of the arbitrary account. The encrypted data is then sent from the SRED reader of the arbitrary account to the secure server. It is preferred that the encrypted data sent is routed through the corresponding POS terminal of the arbitrary account as it is more secure to have the SRED reader not be directly connected to the Internet or other networks. Upon receiving the encrypted data with the secure server, the secure server decrypts the payment instructions and the payment request information with a reader private key, wherein the reader private key is associated with the SRED reader of the arbitrary account and is stored on the secure server. This may be implemented in a variety of means. Preferably, a SRED reader identification (ID) is sent from the SRED reader to the secure server to convey to the secure server which reader private key that should be used to decrypt the payment instructions and payment request information.

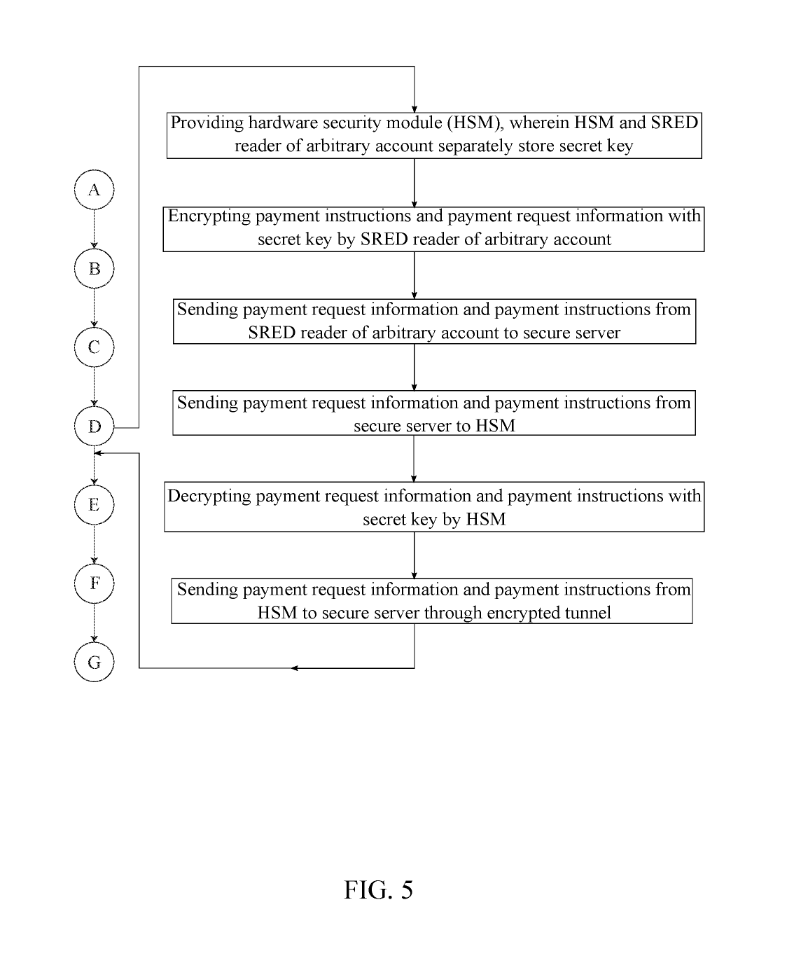

Referring to FIG. 5, in another embodiment of the present invention, data transmitted in between the SRED reader and the secure reader is protected through a symmetric encryption. Symmetric encryption provides a relatively low encryption time, ideal for situations where process time is of high importance. This embodiment is ideal for establishments that process many transactions within a short period of time and require relatively quick response from their financial entity. For example, fast-food establishments like McDonalds and Burger King would prefer this type of encryption as the turnaround time for each customer is a highly valued attribute, for customers and the establishment. Contrary to the asymmetric encryption embodiment of the present invention, the symmetric encryption embodiment requires additional hardware, a hardware security module (HSM) in particular. The HSM is a computing device that is in charge of storing, managing, and safeguarding digital keys; furthermore, the HSM is in charge of the decryption process. The HSM and the SRED reader of the arbitrary account each separately store a secret key. In general, the HSM stores a unique secret key for SRED reader(s) of each merchant account in conjunction with each SRED reader storing the unique secret key. Similar to the asymmetric encryption embodiment, the following steps are executed during step D. For sending data from the SRED reader of the arbitrary account to the secure server by a symmetric encryption, first, the SRED reader of the arbitrary account encrypts the payment instructions and the payment request information into encrypted data with the secret key. Next, the encrypted data is sent from the SRED reader of the arbitrary account to the secure server; where the encrypted data is further redirected to the HSM for decryption. The HSM decrypts the encrypted data with the secret key, the secret key associate with the SRED reader of the arbitrary account, and forwards the payment instructions and the payment request information to the secure server through an encrypted tunnel as this information includes sensitive financial information. The encrypted tunnel provides a secure communication line in between two parties.

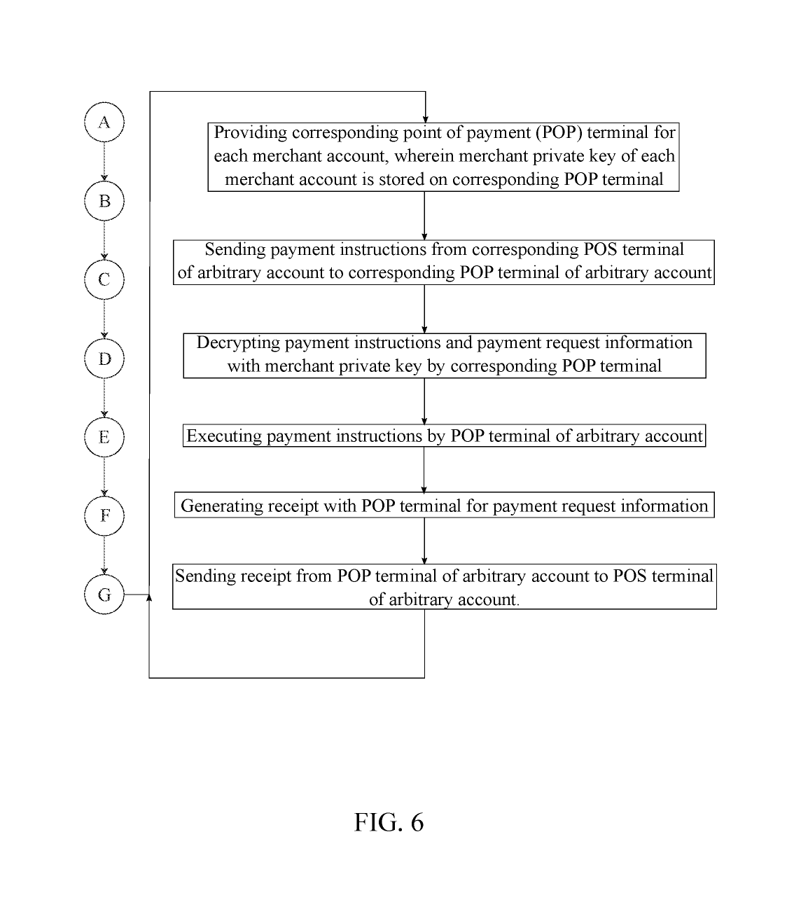

Referring to FIG. 6, a secondary process implemented by the present invention is executing the payment transaction, subs-steps of Step G. More specifically, the payment transaction is executed with a corresponding point of payment (POP) terminal for each merchant account. The POP terminal is the banking entity of each merchant account, although alternative financial institutions may be used to execute the payment transaction. After the corresponding POS terminal of the arbitrary account receives the encrypted payment instructions and payment request information, the corresponding POS terminal of the arbitrary account sends said data to the corresponding POP terminal of the arbitrary account. The POP terminal for each merchant account contains/stores a merchant private key of each merchant account, this allows the POP terminal to decrypt data sent from the POS terminal. The next step includes decrypting the payment instructions and the payment request information with the merchant private key by the corresponding POP terminal. The POP terminal then uses this information to execute the payment instructions and subsequently generate a receipt. Executing the payment instructions includes the transfer of funds from the customer's banking account to the bank account of the arbitrary account. The receipt will reflect the status of the payment transaction, successful or declined essentially. Finally, the receipt is sent from the POP terminal of the arbitrary account to the POS terminal of the arbitrary account.

The present invention may be implemented as an aftermarket solution, wherein a software application which carries out the aforementioned steps is installed onto the POS terminal. Alternatively, the present invention may be integrated into the POS application.

Although the invention has been explained in relation to its preferred embodiment, it is to be understood that many other possible modifications and variations can be made without departing from the spirit and scope of the invention as hereinafter claimed.

What is claimed is:

1. A method for consolidating multiple merchants under a common payment merchant payment system comprises the steps of:
(A) providing a plurality of merchant accounts, wherein each merchant account is associated with a merchant public key and an at least one secure reading and exchange of data (SRED) reader;
(B) providing a secure server and an at least one corresponding point of sale (POS) terminal for each merchant account, wherein the secure server stores the merchant public key for each merchant account;
(C) sending payment request information from the corresponding POS terminal of an arbitrary account to an SRED reader of the arbitrary account, wherein the plurality of merchant accounts includes the arbitrary account;
(D) sending the payment request information and payment instructions from the SRED reader of the arbitrary account to the secure server by a symmetric encryption or an asymmetric encryption;
(E) encrypting payment instructions and the payment request information with the merchant public key of the arbitrary account with the secure server;
(F) sending the payment instructions and the payment request information from the secure server to the corresponding POS terminal of the arbitrary account; and
(G) executing a payment transaction with the corresponding POS terminal of the arbitrary account, wherein the payment request information and the payment instructions are inputs for the payment transaction.

2. The method for consolidating multiple merchants under a common merchant payment system as claimed in claim 1 comprises the steps of:
providing a merchant identification (ID) for each merchant account;
adding the merchant ID of the arbitrary account to the payment request information during step (C);
extracting the merchant ID of the arbitrary account from the payment request information with the secure server; and
identifying a desired public key associated with one of the merchant accounts with the merchant ID of the arbitrary account prior to step (E).

3. The method for consolidating multiple merchants under a common merchant payment system as claimed in claim 1 comprises the steps of:
generating the payment request information by the corresponding POS terminal, wherein the payment request information includes a list of products and a total price;
displaying the payment request information by a user interface for the SRED reader of the arbitrary account; and
receiving the payment instructions through the SRED reader of the arbitrary account, wherein the payment instructions includes a customer name, a bank account number, an expiration date, and a card security code.

4. The method for consolidating multiple merchants under a common merchant payment system as claimed in claim 1 comprises the steps of:
encrypting the payment instructions and the payment request information with a reader public key by the SRED reader of the arbitrary account, wherein the reader public key is associated with the SRED reader of the arbitrary account;
sending the payment request information and the payment instructions from the SRED reader of the arbitrary account to the secure server through the corresponding POS terminal; and
decrypting the payment instructions and the payment request information with a reader private key by the secure server, wherein the reader private key is associated with the SRED reader of the arbitrary account and is stored on the secure server.

5. The method for consolidating multiple merchants under a common merchant payment system as claimed in claim 1 comprises the steps of:
providing a hardware security module (HSM), wherein the HSM and the SRED reader of the arbitrary account separately store a secret key;
encrypting the payment instructions and the payment request information with the secret key by the SRED reader of the arbitrary account;
sending the payment request information and the payment instructions from the SRED reader of the arbitrary account to the secure server;
sending the payment request information and the payment instructions from the secure server to the HSM;
decrypting the payment request information and the payment instructions with the secret key by the HSM; and
sending the payment request information and the payment instructions from the HSM to the secure server through an encrypted tunnel.

6. The method for consolidating multiple merchants under a common merchant payment system as claimed in claim 1 comprises the step of:
logging date, time, and path of the payment instructions and the payment request information through the corresponding POS terminal of the arbitrary account, the SRED reader of the arbitrary account, and the secure server.

7. The method for consolidating multiple merchants under a common merchant payment system as claimed in claim 1 comprises the steps of:
providing a corresponding point of payment (POP) terminal for each merchant account, wherein a merchant private key of each merchant account is stored on the corresponding POP terminal;
sending the payment instructions from the corresponding POS terminal of the arbitrary account to the corresponding POP terminal of the arbitrary account;
decrypting the payment instructions and the payment request information with the merchant private key by the corresponding POP terminal;
executing the payment instructions by the POP terminal of the arbitrary account;
generating a receipt with the POP terminal for the payment request information; and
sending the receipt from the POP terminal of the arbitrary account to the POS terminal of the arbitrary account.
